(19) United States
(12) Patent Application Publication
(10) Pub. No.: US 2014/0028109 A1
(43) Pub. Date: Jan. 30, 2014

(54) WIRELESS POWER TRANSFER SYSTEM FOR FREELY-MOVING ANIMAL EXPERIMENTS

(71) Applicant: Ferro Solutions, Inc., Woburn, MA (US)

(72) Inventors: Jesse Simon, Medford, MA (US); Yiming Liu, Burlington, MA (US); Matthew Farrell, Jamaica Plain, MA (US); Craig Ropi, Brookline, MA (US); Jiankang Huang, Arlington, MA (US)

(73) Assignee: Ferro Solutions, Inc., Woburn, MA (US)

(21) Appl. No.: 13/951,033

(22) Filed: Jul. 25, 2013

Related U.S. Application Data
(60) Provisional application No. 61/675,564, filed on Jul. 25, 2012.

(51) Int. Cl. H01F 38/14

(52) U.S. Cl. CPC H01F 38/14
USPC 307/104

(57) ABSTRACT

Disclosed herein are systems and methods for wirelessly transmitting power to receivers that are freely mobile, such as power receivers for sensors attached to animal experiments. An example transmitter includes a resonator including a generator and transmitter coil, an initial drive signal generator that removes the generator from an ‘off’ state thereby causing the transmitter coil to create an alternating magnetic field that oscillates within a threshold of a resonant frequency of the generator, a phase detector that receives a signal from a receiver coil receiving power via the magnetic field, and a transition module that switches from the initial drive signal to a drive signal generated based on output from the phase detector. An example wireless power receiver has three turns of wire, one on each axis, around a ferrite plate, the outputs of which are connected in parallel to produce a combined output power signal.

### RELATED APPLICATIONS

This application claims priority to U.S. Provisional Patent Application No. 61/675,564, filed 25 Jul. 2012, the contents of which are herein incorporated by reference in their entirety.

### BACKGROUND

1. Technical Field

The present disclosure relates to power transmission and more specifically to providing continuous power to a receiver carried by a free-moving object, such as an animal in an experiment.

2. Introduction

Many lab experiments on animals, such as mice or rabbits, require continual monitoring. One way to monitor experiments on animals is to attach or implant biomedical electronic devices to the animals. However these biomedical electronic devices typically require a power supply. A battery is one solution to providing power, but batteries can be bulky or heavy, and can die, which requires monitoring and changing to ensure continuous experiment results. A connective cable is another solution to providing power, but this can restrict the movement of the animals, and can be prone to failure if the cables get tangled, break or fall off, and so forth. Yet another solution to providing power to such biomedical electronic devices is providing power wirelessly through electromagnetic induction. For example, the animals and wireless power receivers can be contained within a space near or proximate to a wireless power transmitter.

Wireless power transmission addresses many of the deficiencies of batteries or connective cables, but can introduce other problems. For example, power transmission via induction can generate excess heat, which can cause discomfort to experiment animals, or which may disrupt the experiment or taint the experiment results. Wireless powered implanted brain biomedical electronics overheating can cause damage to brain tissue. Similar heat-related damage can occur in other implanted biomedical devices such as retinal prosthesis. The overheating problem is a much more concerned issue in a high efficiency resonant inductive coupling system where flux concentrator is used in the power receiver coil. Closed loop approaches are employed in wireless power transfer system to ensure optimal power transfer level for proper operation and avoid tissue damage. But such closed loop added complexity and power burden to the system. In situations of multiple receivers, such as when a single container houses multiple test animals, the closed loop approaches is not effective or useful.

Oscillating magnetic fields are commonly generated using one or multiple reactive elements, such as 2 capacitors, along with a transmission coil to create a resonator, which allows current to efficiently flow through the transmitting coil at a specific frequency known as the generator's resonant frequency. To force the generator to operate at or close to its resonant frequency, a crystal oscillator or some other frequency generator is commonly used. Using a fixed-frequency oscillator to drive such a generator always results in some finite difference between the resonant frequency of the generator and the frequency at which the generator is being driven. This difference can be relatively large and can vary by temperature, the properties of surrounding elements, manufacturing tolerances and other factors. The difference can lead to additional inefficiencies in the wireless power transmission.

### SUMMARY

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

Set forth herein is a wireless power transfer system specifically designed for use in freely-moving animal experiments. The system can provide over 200 mW of continuous power to receivers carried by or in the animal via a power transmitter located beneath, near, or proximate to the animal cage. The power transmitter can include a rectangular, spiral, figure eight transmit coil that provides nearly uniform magnetic field magnitude over area of a standard animal cage. The power transmitter can include an aluminum plate in the base of the transmitter that acts as an “eddy-current mirror” to shield the system from the effect of other metallic objects such as a steel work surface beneath the transmitter, to reduce the inductance of the transmitter coil thereby lowering the coil voltage, and to reflect and therefore magnify the vertical (z) component of the magnetic field, allowing fewer turns to be used in the transmitter coil. The power transmitter can include a highly-efficient, resonant inverter circuit to drive the coil at its resonant frequency. The power transmitter can receive a transistor-transistor logic (TTL) input to switch the charging field on and off.

An example power receiver includes a 3-axis inductive antenna, which a test subject animal can carry. The 3-axis design allows the antenna response to be nearly independent of field direction. Thus, although the field direction changes over the transmitter surface, receiver response is uniform or nearly uniform. Also, receiver response will be relatively unaffected by changes in orientation of the antenna due to animal motion. The number of turns on the coil can be optimized so that peak power is achieved at a voltage of approximately 10 V. A typical RFID antenna would produce hundreds of volts at this field strength, so reducing the number of turns produces power at a lower voltage, which the system can convert and store more efficiently. The power receiver can be attached to or include a battery for storing received power.

The power transmitter can increase in temperature during continuous operation. To address this, the power transmitter can include a passive cooling system to reduce surface temperature. An active cooling system, such as a fan, would produce vibrations that could affect animal behavior. In addition, passive cooling allows the system to be sealed, facilitating cleaning. The system can prevent the power transmitter and other electronics in a wireless power transfer system from overheating by using a low Curie temperature ferrite flux concentrator in the receiving coil. When the power transmitter temperature increases to the ferrite Curie temperature, the permeability of the ferrite decreases dramatically. This change in permeability has two effects to the operation of the wireless power transfer system. First, the receiver loses its flux concentrator function. Second, the transmitter de-tunes the resonant inductive coupling between the power transmitter and the receiver, therefore reducing the power transferred to minimum. When the transmitter temperature returns to a normal operation temperature below the Curie temperature, the power transfer resumes normal operation automatically. The Curie temperature of ferrites, such as ferrites made of manganese and zinc, can be engineered for specific ranges of Curie temperatures for various applications.

Also disclosed herein is a method for driving an oscillating electro-magnetic field generator at its resonant frequency, regardless of changes to the generator's resonant frequency due to environmental changes or manufacturing tolerances, by using the generated electro-magnetic field to derive the timing signal that controls the frequency at which the polarity of the voltage across the generator's coil oscillates.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1A illustrates a first transmitter coil design;

FIG. 1B illustrates a first representative corresponding magnetic field generated by a transmitter coil in the X axis;

FIG. 2A illustrates a second transmitter coil design;

FIG. 2B illustrates a second representative corresponding magnetic field generated by a transmitter coil in the Y axis

FIG. 3A illustrates a third transmitter coil design;

FIG. 3B illustrates a third representative corresponding magnetic field generated by a transmitter coil in the Z axis

FIG. 4 illustrates a norm of the magnetic field |H|=\sqrt{Hₓ²+H_{y}²+H_{z}²};

FIG. 5A illustrates an example wireless power transmitter and cage;

FIG. 5B illustrates an example partial layout of a wireless power transmitter;

FIG. 5C illustrates an example schematic of a wireless power transmitter;

FIG. 6A illustrates an example wireless power receiver;

FIG. 6B illustrates an example partial layout of a wireless power receiver;

FIG. 6C illustrates an example three axis inductive wireless power receiver;

FIG. 6D illustrates an example schematic of a wireless power receiver;

FIG. 7 illustrates available power at positions above the example wireless power transmitter;

FIG. 8 illustrates power received by a three axis receiver;

FIG. 9 illustrates an example configuration with one transmitter array and multiple animal-borne receivers;

FIG. 10 illustrates an example method embodiment;

FIG. 11 illustrates a first example system embodiment for adding initial and derived signals;

FIG. 12 illustrates a second example system embodiment for adding initial and derived signals;

FIG. 13 illustrates a first example system embodiment for determining an amplitude of a derived signal, and switching to the derived signal when the amplitude crosses a threshold;

FIG. 14 illustrates a second example system embodiment for determining an amplitude of a derived signal, and switching to the derived signal when the amplitude crosses a threshold;

FIG. 15 illustrates a first example system embodiment for determining current in a transmission coil, and switching to the derived signal when the current crosses a threshold;

FIG. 16 illustrates a second example system embodiment for determining current in a transmission coil, and switching to the derived signal when the current crosses a threshold;

FIG. 17 illustrates a first example system embodiment for switching between an initial drive signal and a derived drive signal after a defined period of time;

FIG. 18 illustrates a second example system embodiment for switching between an initial drive signal and a derived drive signal after a defined period of time;

FIG. 19 illustrates a first example oscilloscope capture of several signals according to an example implementation of what is shown in FIG. 11;

FIG. 20 illustrates a first example oscilloscope capture of several signals according to an example implementation of what is shown in FIG. 11; and

FIG. 21 illustrates an example system embodiment.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

The various approaches, devices, systems, and methods disclosed herein can be used to wirelessly transmit and/or receive power from a transmitter coil to one or more free-moving wireless power receivers, such as wireless power receivers that provide power for animal-borne sensor equipment. The transmitter does not interfere with test subjects, such as animals, and provides an evenly available field to wireless power receivers on the test subjects so that sensors or other electronic devices on the test subjects can receive power without relying on a wired power connection or on replaceable, bulky batteries or other removable power supplies.

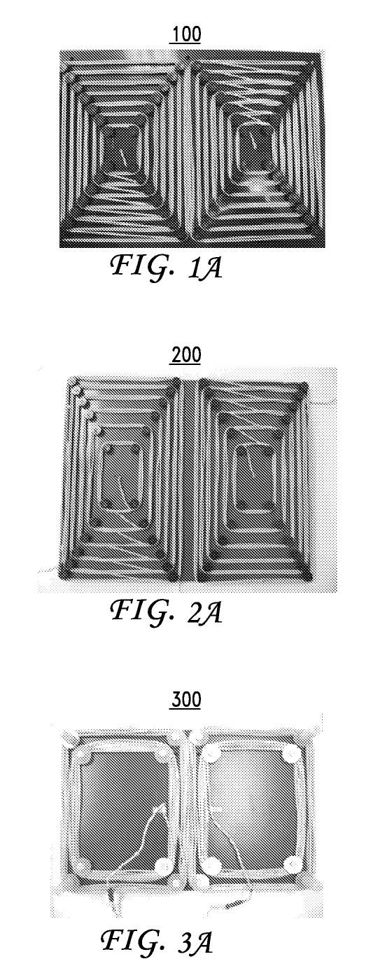

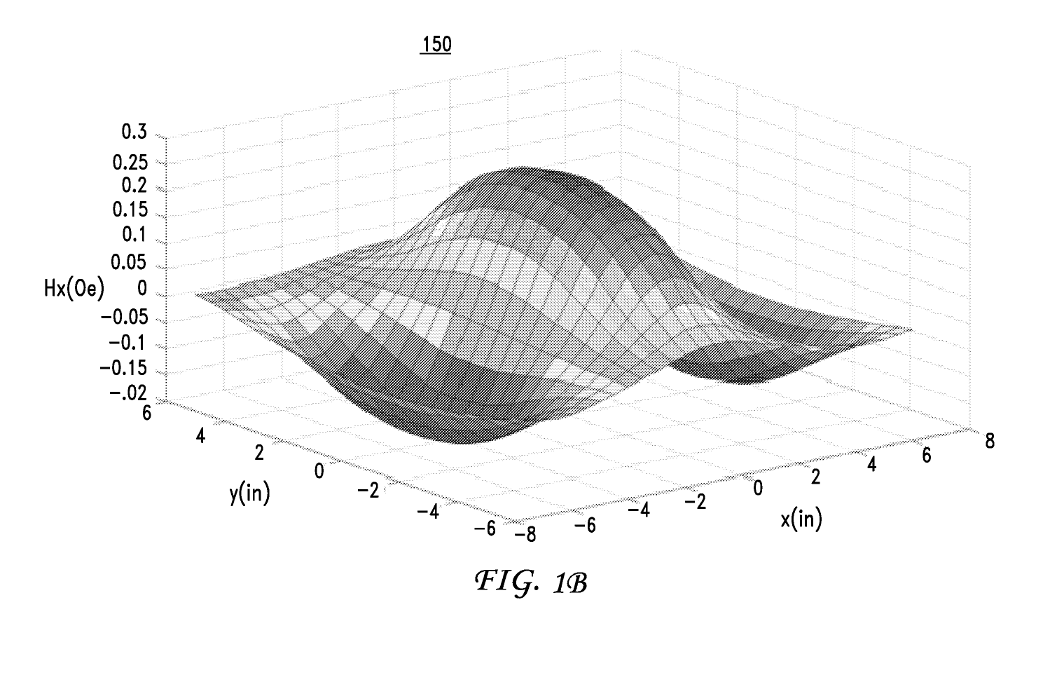

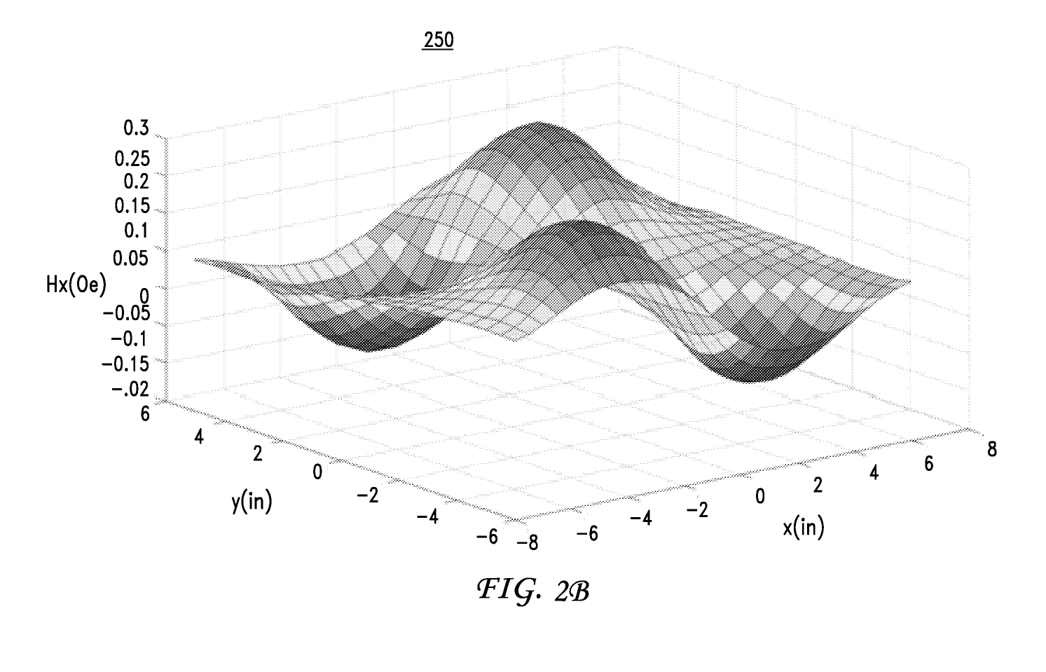

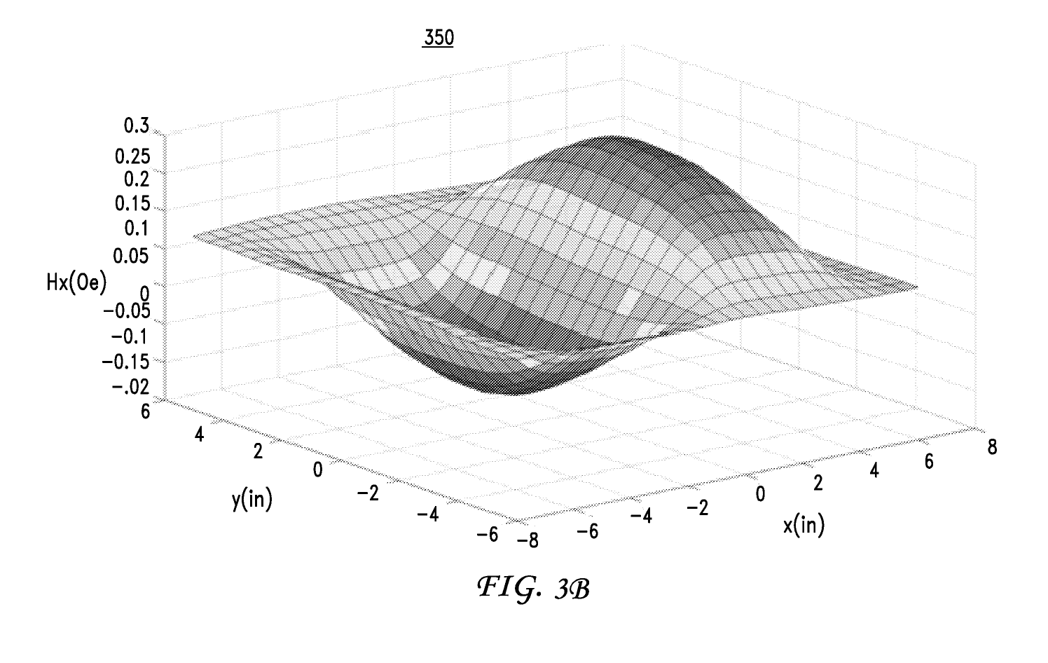

FIGS. 1A, 2A, and 3A each illustrate transmitter coil designs 100, 200, 300 arranged in different variations of a rectangular figure eight pattern. Each of these coil patterns produces an electro-magnetic field that comes “up” through the coil on one side of the figure eight, and “down” through the other side. The transmitter coil 300 of FIG. 3A illustrates fewer turns at the center of the figure eight loops, which an eddy-current mirror below the coil can reflect and magnify the normal field component Hz. The eddy-current mirror can be constructed of aluminum or any other suitable electro-magnetic reflective material or materials. The eddy-current mirror can be a solid flat plate, angled plates, a lining or film, or a collection of separate components. Further, the eddy-current mirror can include holes or perforations. At a given reflector separation, the size of the inner loops of the coil may be optimized to provide a nearly-uniform field distribution over the coil.

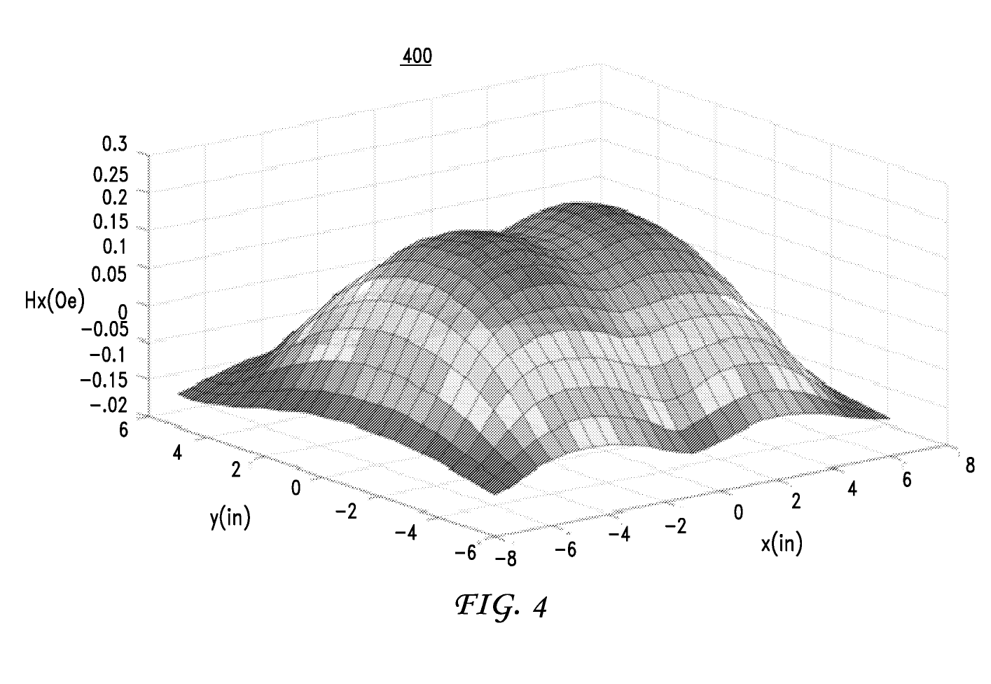

FIG. 1B illustrates a first representative corresponding magnetic field 150 generated by one of the coils of FIG. 1A, 2A, or 3A, in the X axis. The magnetic field is positive along a linear area of the center, and negative at the edges. FIG. 2B illustrates a second representative corresponding magnetic field 250 generated by one of the coils of FIG. 1A, 2A, or 3A, in the Y axis. The magnetic field is positive in two opposite corners of the region, and negative in the other two corners. FIG. 3B illustrates a second representative corresponding magnetic field 350 generated by one of the coils of FIG. 1A, 2A, or 3A, in the Z axis. The magnetic field is positive on one side of the region and negative on the other side. The chart 400 of FIG. 4 illustrates the norm of the magnetic field |H|=\sqrt{Hₓ²+H_{y}²+H_{z}²} across the X, Y, and Z axes, showing how the magnetic field of the three axes is more steady and consistent when normed than the individual magnetic fields are separately.

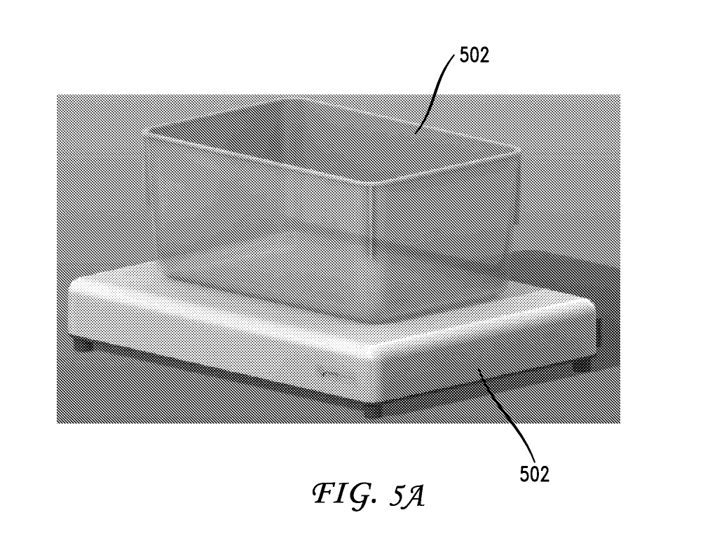

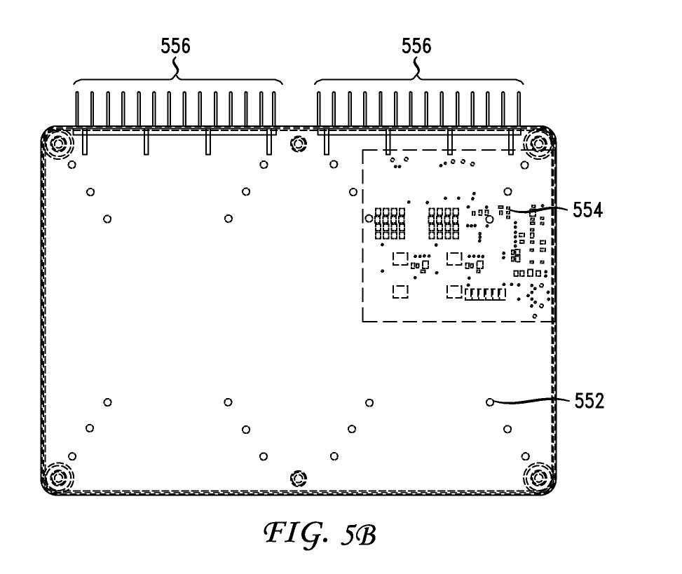

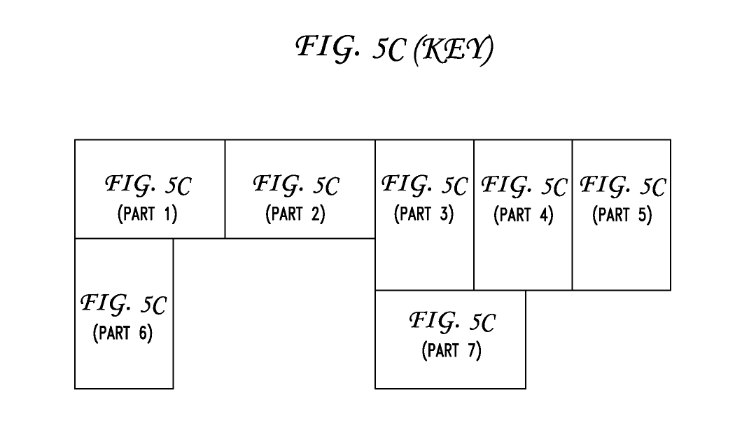

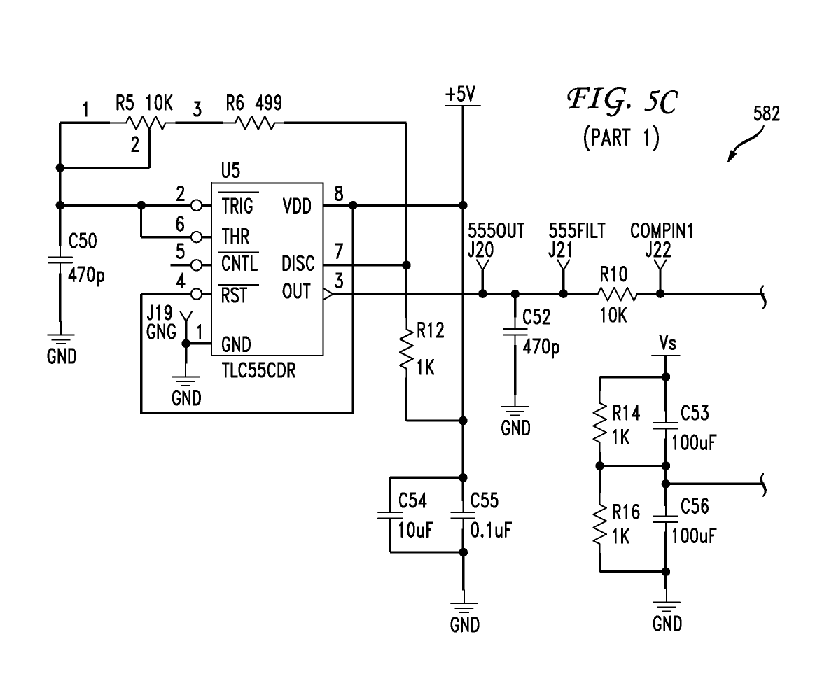

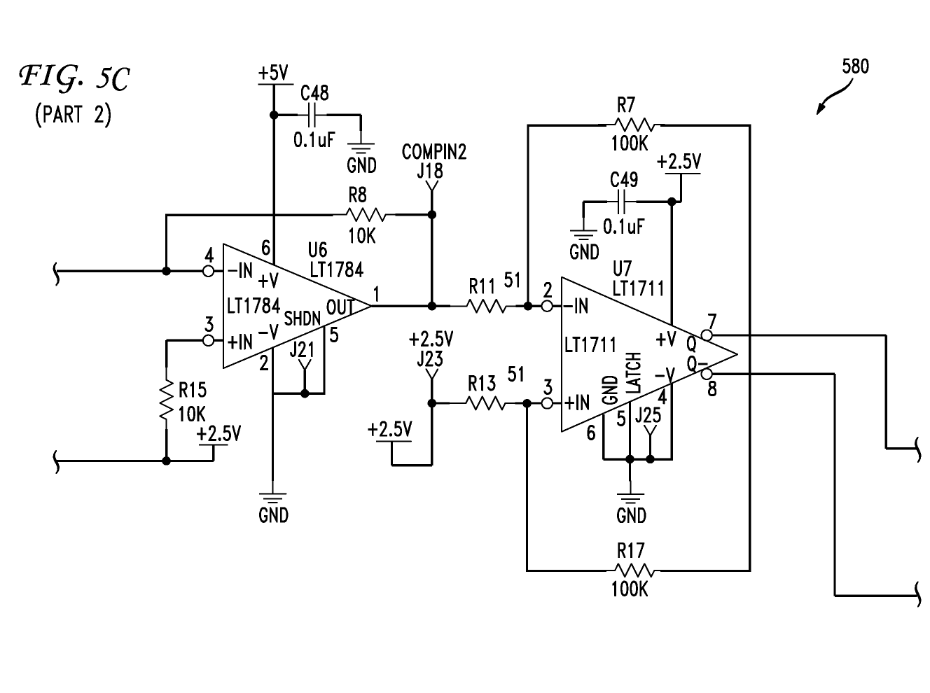

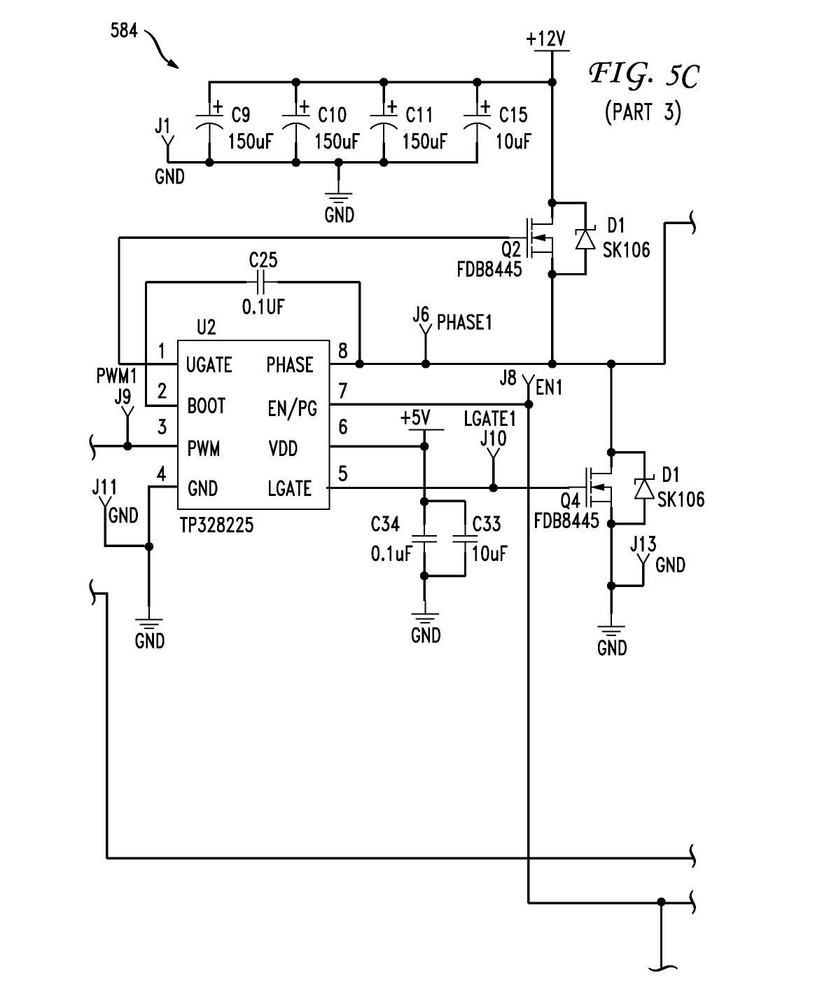

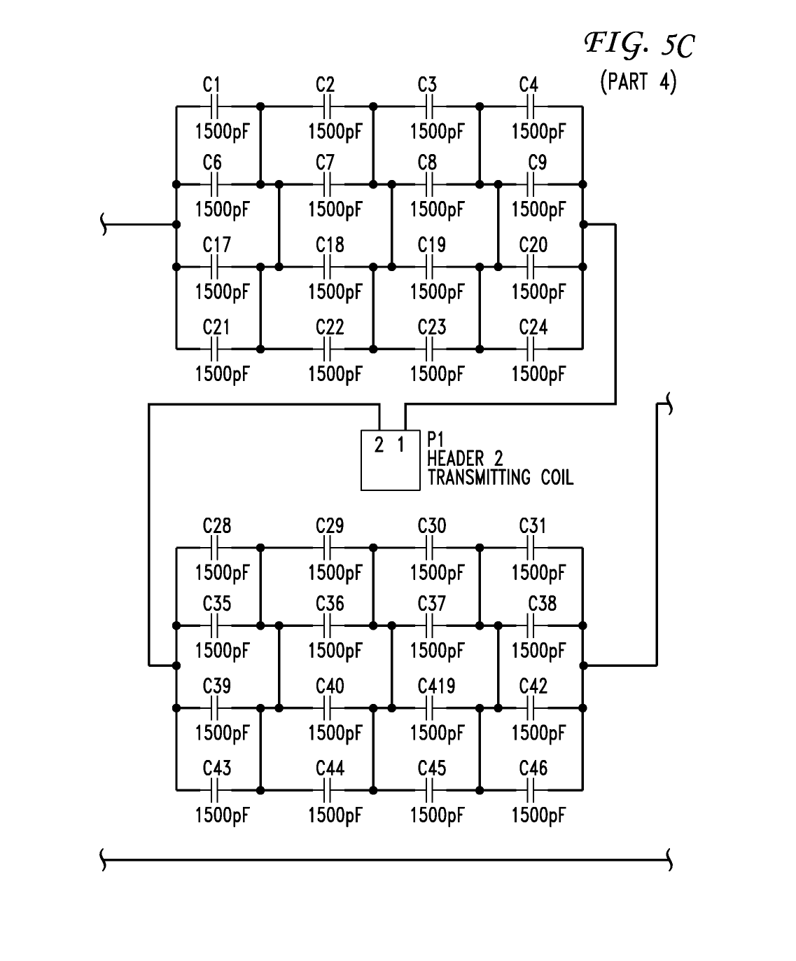

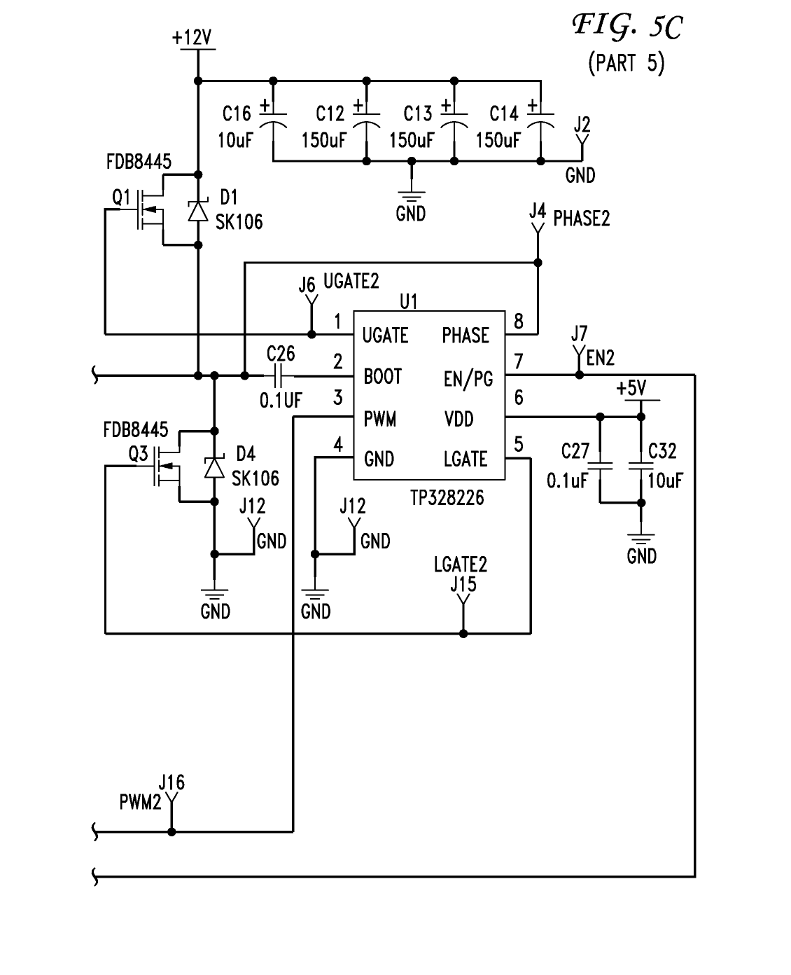

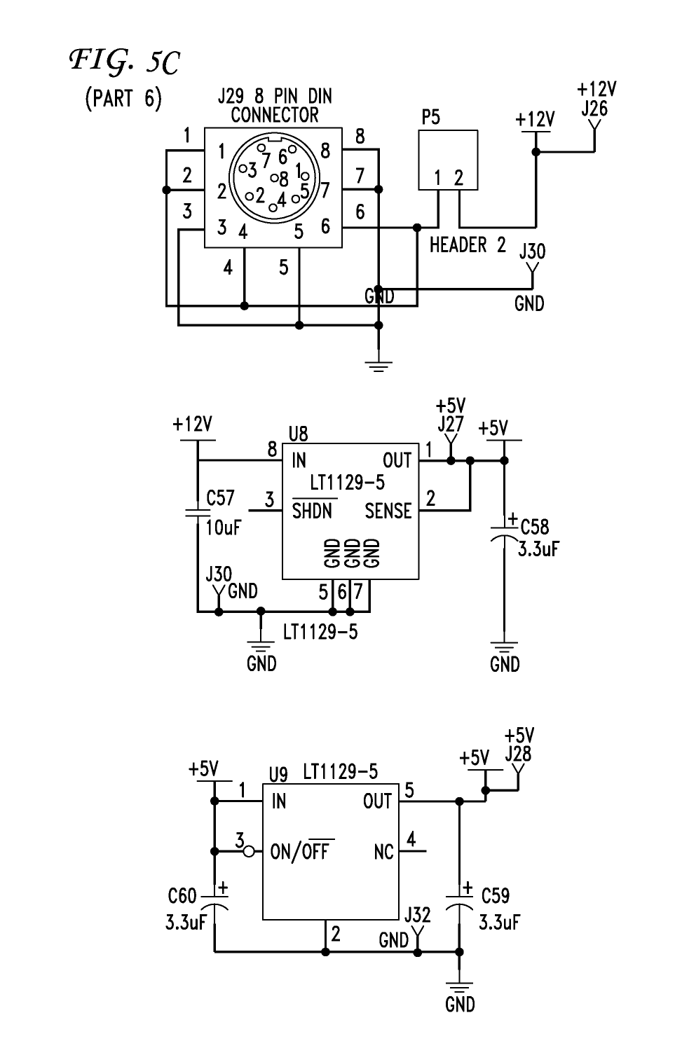

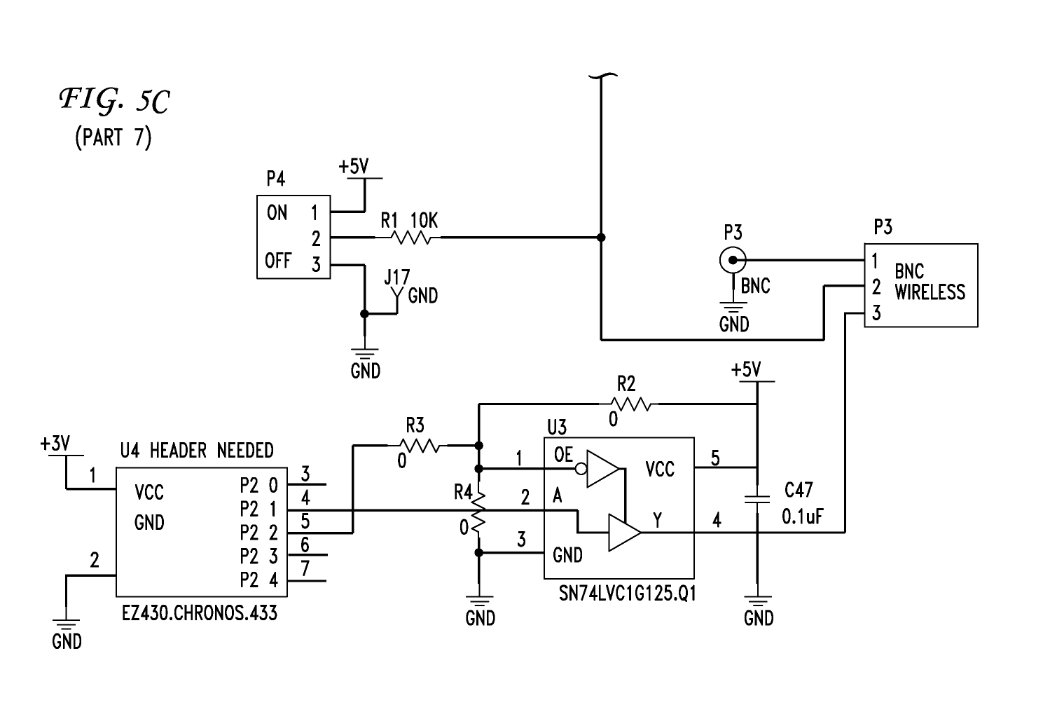

FIG. 5A illustrates an example wireless power transmitter 502 and cage 504. The wireless power transmitter 502 can be connected to a power supply, and transmit power wirelessly to receivers attached to animals in the cage 504. Other types or shapes of cages or wireless power transmitters can be used. The cage can be shaped in such a way to contain the animals in a desired region of the magnetic field which is most efficient for wireless power transfer or a part of the magnetic field that has some other desired characteristic. In one variation, the cage 504 can also incorporate a power receiver to power lights, sensors, or other electronic devices, such as a scale, a display, or a speaker. While the examples herein primarily discuss animal-borne wireless power receivers, the wireless power receivers can be attached to any mobile object, such as a ball, an insect, a growing plant or a plant that moves to follow a light source, humans, personal electronic devices, and so forth.

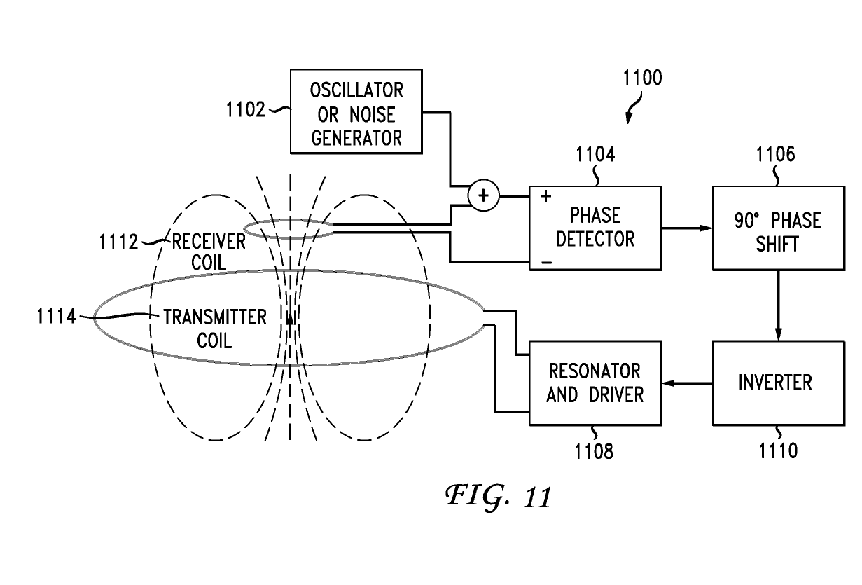

FIG. 5B illustrates an example partial layout 550 of a part of a wireless power transmitter 502. The wireless power transmitter 502 can include coil winding posts 552 for supporting the structure of the transmitter coils, or simply for ease of production. The wireless power transmitter 502 can also include a resonant inverter circuit 554 that implements logic for controlling how and when the signals are inverted, such as the resonator 1108 and inverter 1110 discussed in FIG. 11. The wireless power transmitter 502 can include heatsinks 556 to provide passive cooling for the entire wireless power transmitter 502 unit. Alternatively, depending on the specific application, the wireless power transmitter 502 can be actively cooled, such as by a fan, or the wireless power transmitter 502 may require no cooling or heatsink. The wireless power transmitter 502 can use a passive cooling system to reduce surface temperature during continuous operation. Avoiding the use of a fan allows the construction of a sealed system, which can allows for simpler cleaning, and eliminates vibration that could affect animal behavior. In situations that require long periods of continuous power transfer, heat transfer may be reduced by placing a thin insulating sheet between the transmitter and mouse cage. FIG. 5C illustrates an example schematic 580 of a wireless power transmitter 502. The schematic 580 of the wireless power transmitter 502 shows a first section 582 for receiving various inputs, which is connected to a second section 584 for transmitting.

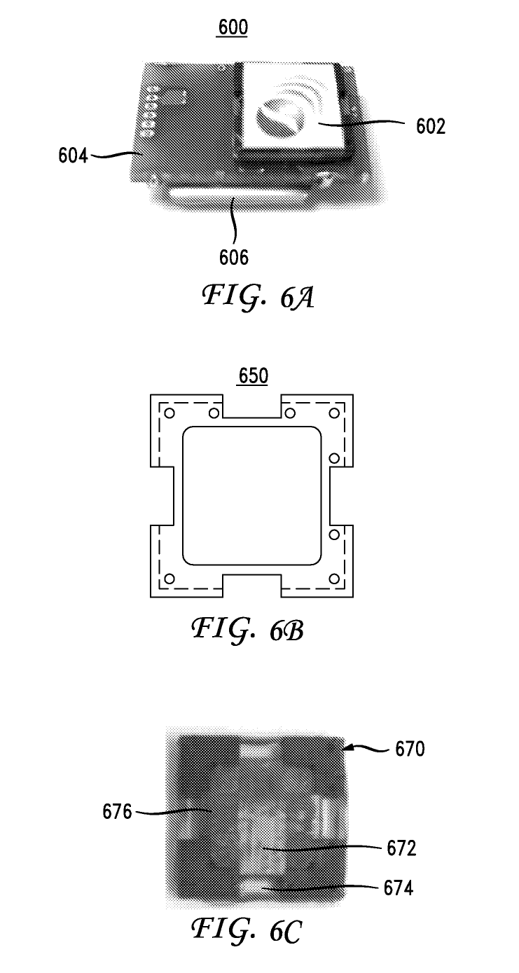

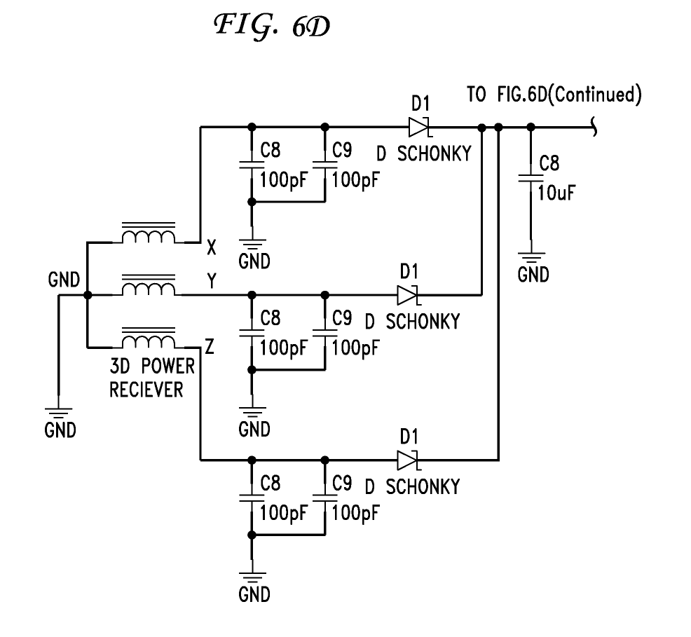

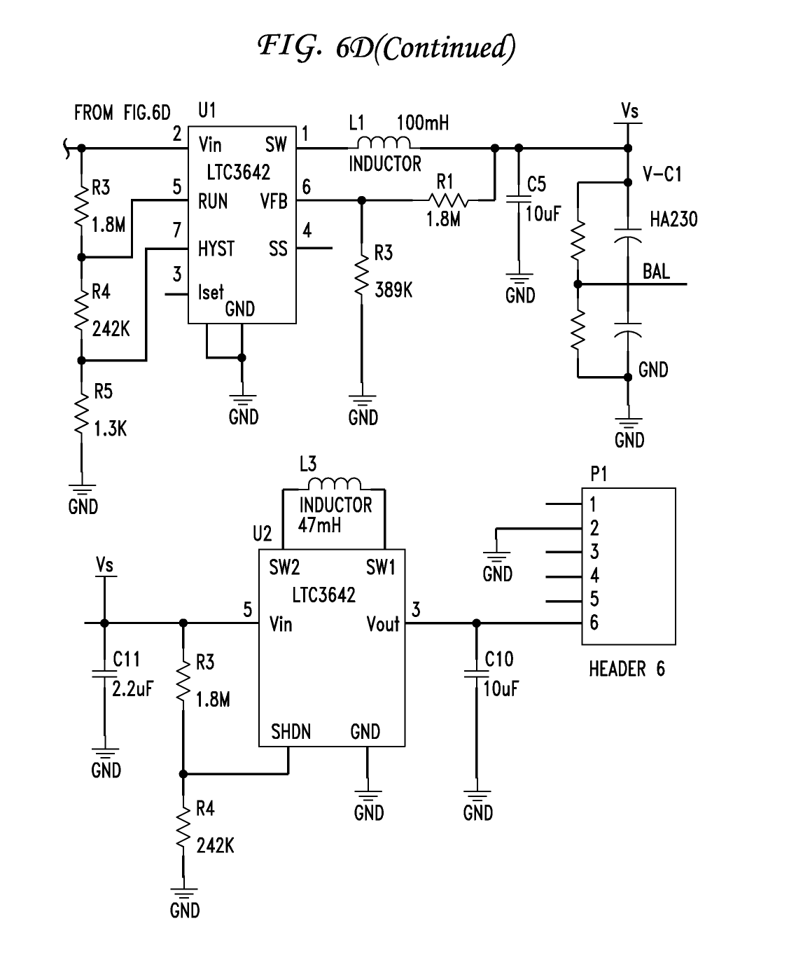

FIG. 6A illustrates an example wireless power receiver unit 600 which receives power from the wireless power transmitter 502. The wireless power receiver unit 600 can include a three-axis wireless power receiver 602 mounted to a PCB 604 which can optionally include various logic, sensors, controllers, or other connective circuitry or functional components. A battery, capacitor, or supercapacitor 606 can store power received through the wireless power receiver 602. In this way, the wireless power receiver unit 600 can provide regulated DC output and optional energy storage for a sensor or other electronic device. FIG. 6B illustrates an example partial layout 650 of a wireless power receiver 602. The layout 650 is an example of one design of a ferrite plate, which can be substantially square or any other suitable shape, size or design, which provides a way to wrap wire in three different axes. Wire can be wrapped from top to bottom between the upper and lower notches in the layout 650, can be wrapped from side to side between the left and right notches in the layout 650, and can be wrapped around the entire exterior of the layout 650. FIG. 6C illustrates one example three-axis inductive wireless power receiver 670 with the wires wound around the three axes. The inductive wireless power receiver 670 has a first collection 672 of approximately 50 turns of magnet wire wound around a first axis, a second collection 674 of approximately 50 turns of magnet wire wound around a second axis, and a third collection 676 of approximately 50 turns of magnet wire wound around a third axis. The three antenna outputs are each connected in parallel, such as with a low-loss capacitor having a value such that each coil resonates at the driving frequency of the transmitter. Each output can be rectified separately before being combined. The resulting DC output voltage may then be converted or used to charge a supercapacitor or battery 606. FIG. 6D illustrates an example electrical schematic 680 of a wireless power receiver 602.

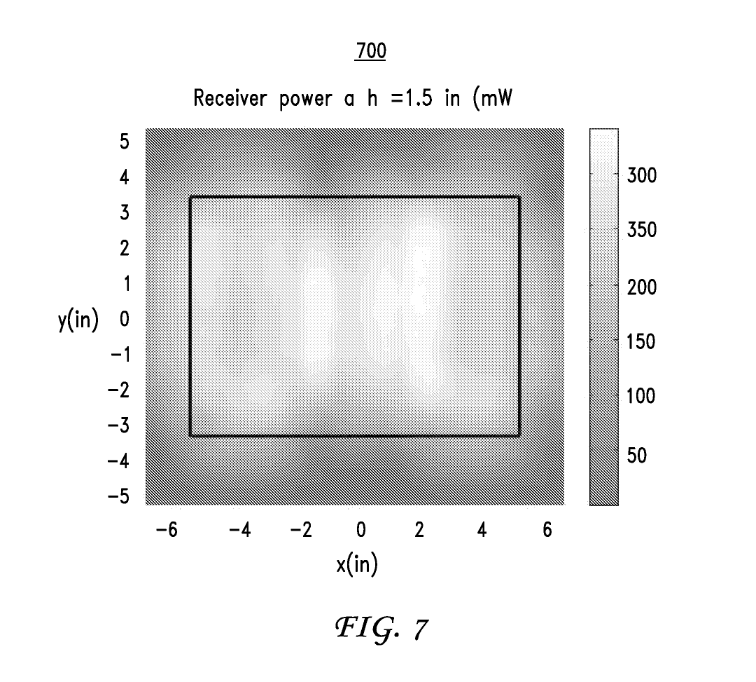

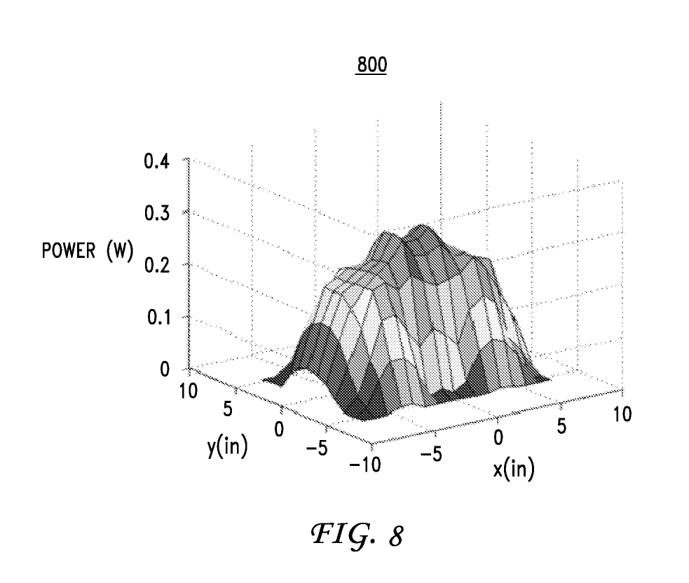

FIG. 7 is a chart 700 illustrating available power to a wireless power receiver at positions 1.5 inches above the example wireless power transmitter. The area enclosed by the dark rectangle represents the interior region of an example cage resting on the wireless power transmitter 502. FIG. 8 is a similar chart 800 illustrating power received by an example three axis receiver under test conditions 1.5 inches above a figure eight transmit coil with a coil current of 10 A. The three-axis inductive receiver demonstrates a nearly uniform power distribution may be achieved over the central area of the transmitter. While the chart 800 indicates two peaks at the center, the overall power distribution is much more uniform and even than in other configurations.

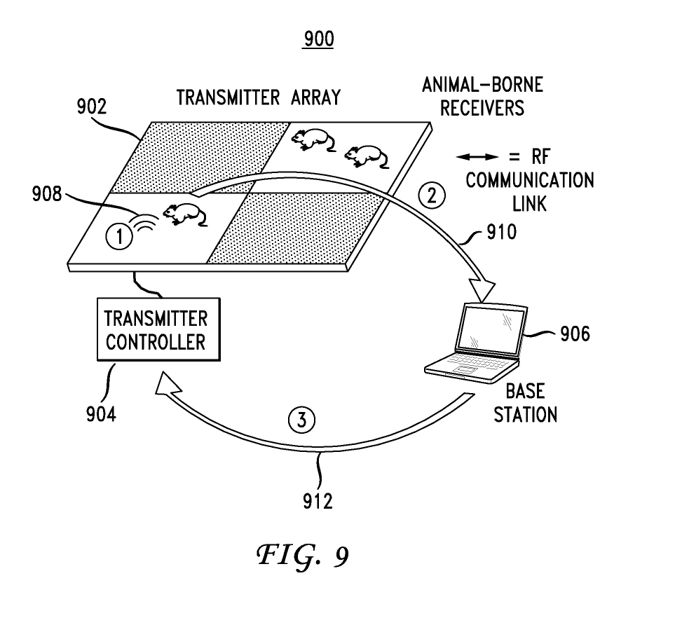

FIG. 9 illustrates an example configuration 900 with one transmitter array 902 and transmitter controller 904, a base station 906, and multiple animal-borne receivers 908. The animal-borne receivers 908 can be three-axis receivers or other suitable inductive power receivers. The transmitter control can provide a level of intelligence to control the transmission of power. The magnetic field from each tile of the transmitter array 902, which is in a low-power state by default, can encode a unique identifier which identifies 908 the tile in the transmitter array 902 to an animal-borne receiver 908 above it. The animal-borne receiver 908 relays 910 the identifier to the base station 906. Then the base station 906 communicates 912 with the transmitter controller 904, which can increase the power output of that tile according to the number of receivers identified in an area corresponding to that tile. In this example, the tile in the upper right transmits more power than the tile in the lower left, because two animal-borne receivers 908 are on the upper right tile and only one animal-borne receiver 908 is on the lower left tile. Similarly, both the upper right and lower left tiles transmit more power than the other two tiles in the transmitter array 902 where no animal-borne receivers are present. As the transmitter controller 904 detects movement of the animal-borne receivers 908 between tiles, the transmitter controller 904 adjusts the power output of the appropriate tiles up or down accordingly. This approach is more efficient, and can reduce the problems of overheating by only providing power to where it is needed.

In one variation, the animal-borne receivers can provide the base station 906 with additional information besides the unique identifier for a particular tile in the transmitter array 902. The animal-borne receiver can provide receiver-specific data or requirements to the base station 906, so that the base station 906 and/or the transmitter controller 904 can adjust the corresponding tile accordingly. An animal-borne receiver attached to a sensor element having a higher power requirement can cause the base station 906 and/or the transmitter controller 904 to transmit more power to the corresponding tile than it would for a different type of animal-borne receiver. Beyond that, the animal-borne receiver can transmit real-time power consumption requirements to the base station 906, so that the transmitter controller 904 can transmit sufficient power to provide for the real-time power consumption requirements.

In addition, the system can prevent or reduce overheating by using a low Curie temperature ferrite material as the flux concentrator. This material can prevent overheating of the receiving electronics in inductive wireless power transfer system for implanted biomedical devices, especially when transmitting power to multiple receivers. Power receivers often increase in temperature during continuous operation. The system can prevent the power receiver and other electronics in a wireless power transfer system from overheating by using a low Curie temperature ferrite flux concentrator in the receiving coil. When the power receiver temperature increases to the ferrite Curie temperature, the permeability of the ferrite decreases dramatically so that the receiver loses its flux concentrator function, and the receiver de-tunes the resonant inductive coupling between the power transmitter and the receiver, therefore reducing the power transferred to minimum. When the receiver temperature returns to a normal operation temperature below the Curie temperature, the power transfer resumes normal operation automatically based on the properties of the material and its Curie temperature. The Curie temperature of ferrites, such as ferrites made of manganese and zinc, can be engineered for specific temperature ranges Curie temperatures for various applications. For example, some example ferrite materials having a cure temperature of 37 C to 80 C include MnZn or NiZn. This approach can also apply to other wireless power transfer situations that require overheating protection for proper device function. Other types of mobile receivers besides animal-borne receivers can communicate with the base station 906 and the transmitter controller 904.

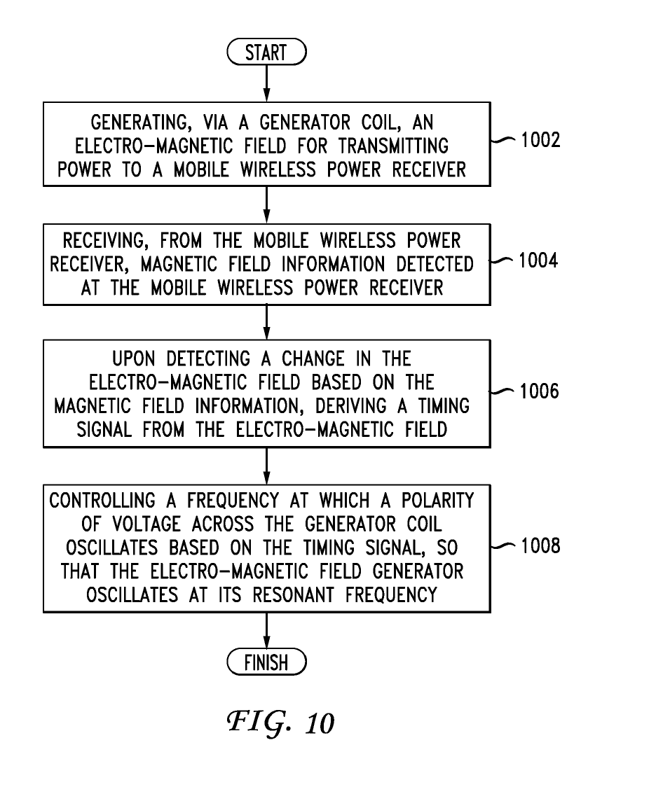

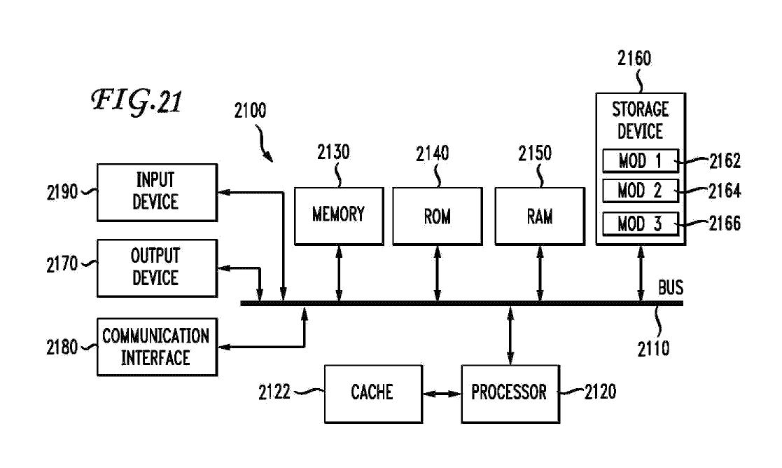

Having disclosed some basic system components and concepts, the disclosure now turns to the exemplary method embodiment shown in FIG. 10. For the sake of clarity, the method is discussed in terms of an exemplary system 2100, as shown in FIG. 21, configured to practice the method. The steps outlined herein are exemplary and can be implemented in any combination, permutation, or order thereof, including combinations or permutations that exclude, add, or modify certain steps. A system configured to practice the method can generate, via a generator coil, an electro-magnetic field for transmitting power to a mobile wireless power receiver (1002). The system can identify the generator coil from an array of generator coils based on an indication that at least one mobile wireless power receiver is proximate to the generator coil.

The system can receive, from the mobile wireless power receiver, magnetic field information detected at the mobile wireless power receiver (1004). In one scenario, the system can receive magnetic field information from multiple mobile wireless power receivers, such as when multiple animals in an animal experiment are in a same cage. The system can receive the magnetic field information via a base station. Upon detecting a change in the electro-magnetic field based on the magnetic field information, the system can derive a timing signal from the electro-magnetic field (1006). The system can control a frequency at which a polarity of voltage across the generator coil oscillates based on the timing signal, so that the electro-magnetic field generator oscillates at its resonant frequency (1008). The system can control the frequency via a transmitter controller.

An example wireless power transmitter can include a resonator made of a generator and a transmitter coil, an initial drive signal generator which applies an initial drive signal comprising an alternating current signal, the initial drive signal removing the generator from an off state thereby causing the transmitter coil to create an alternating magnetic field that oscillates within a threshold of a resonant frequency of the generator, a phase detector that receives a signal from a receiver coil receiving power via the alternating magnetic field from the transmitter coil, and a transition module that switches from the initial drive signal to a drive signal generated based on output from the phase detector. The example wireless power transmitter can also include a phase shifter module that phase shifts the drive signal by 90 degrees, and a phase inverter module that inverts the drive signal to bring the drive signal back in phase with the initial drive signal. The initial drive signal generator can be an oscillator and/or a noise generator. The transmitter coil can be a single transmitter coil of a simple polygonal or circular shape, or a single transmitter coil in a figure eight shape. The drive signal can be a square voltage signal from a voltage output received from the receiver coil.

An example wireless power receiver can include a ferrite plate, a first antenna comprising a first set of turns of wire around the ferrite plate in an X axis, a second antenna comprising a second set of turns of wire around the ferrite plate in a Y axis, and a third antenna comprising a third set of turns of wire around the ferrite plate in a Z axis. The first antenna, the second antenna, and the third antenna produce outputs when in the presence of an alternating magnetic field generated by a transmitter coil. A connector can connect the outputs in parallel to produce a combined output signal. The wireless power receiver can include a low Curie temperature ferrite flux concentrator configured to reduce permeability of the low Curie temperature ferrite flux concentrator as a temperature of the low Curie temperature ferrite flux concentrator increases above a threshold, and to increase permeability of the low Curie temperature ferrite flux concentrator as the temperature of the low Curie temperature ferrite flux concentrator decreases below the threshold. The low Curie temperature ferrite flux concentrator can be made of at least one of MnZn or NiZn. The threshold for the low Curie temperature ferrite flux concentrator can be between 37 degrees Celsius and 80 degrees Celsius. The connector can be a low loss capacitor having a value such that each antenna resonates at a driving frequency of the transmitter coil. A rectification module can rectify the individual outputs from the antennae prior to producing the combined output signal. A power storage module such as a battery, capacitor, or supercapacitor can store power received via the combined output signal. Each of the first set of turns of wire, the second set of turns of wire, and the third set of turns of wire can include between 40 and 60 turns.

FIGS. 11-18 depict various system embodiments. Portions of the system are represented by function blocks, and arrows represent the flow of information between the function blocks. The system embodiments are examples and can be modified to include, rearrange, combine, or remove certain elements within the spirit and scope of the disclosure.

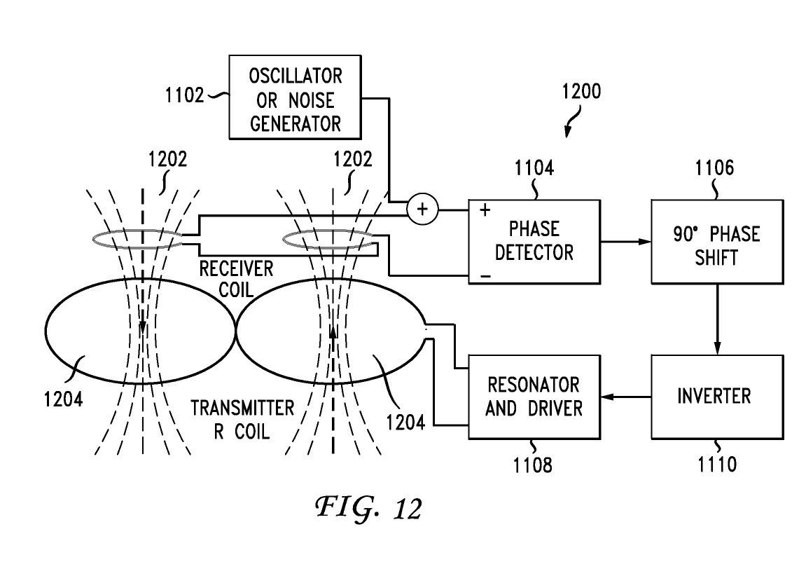

Four separate system embodiments are depicted in FIGS. 11-18 for determining when the switch from the initial drive signal to the derived drive signal should occur. The first embodiments 1100, 1200, which are displayed in FIGS. 11 and 12, add the initial and derived drive signals together, with the initial drive signal having significantly less amplitude than the derived drive signal when the system is in an ‘on’ steady state. This allows the derived signal to overpower the initial drive signal as its amplitude increases, until the initial drive signal can be considered negligible.

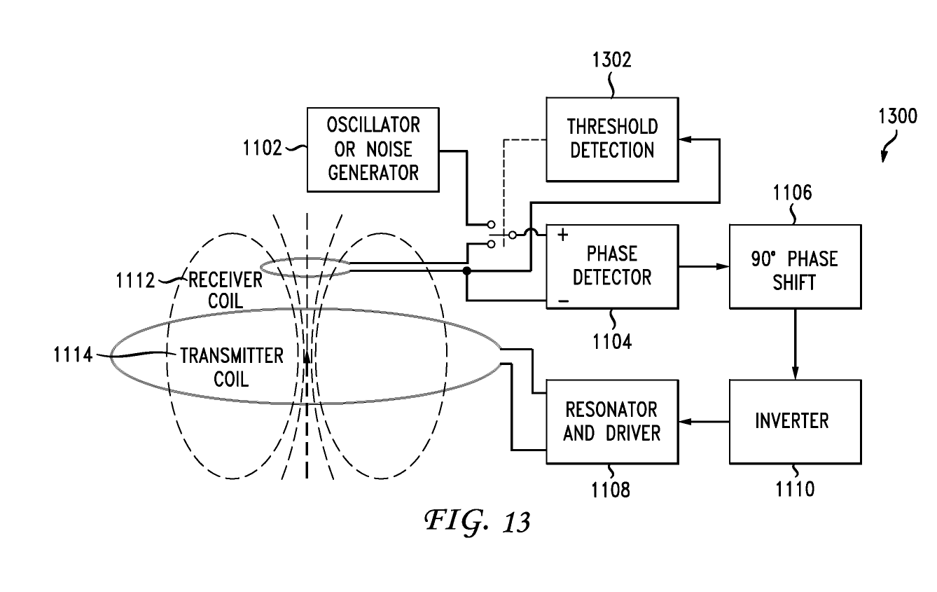

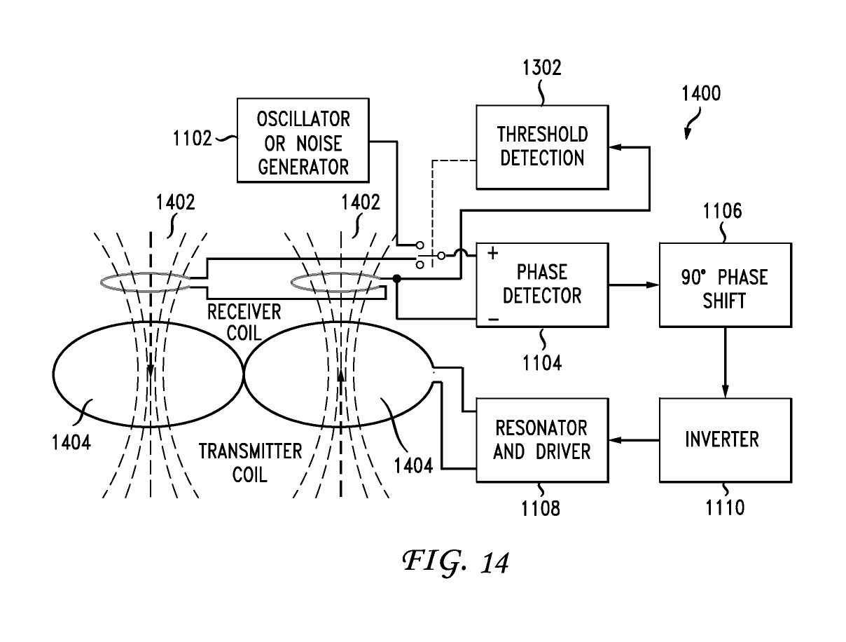

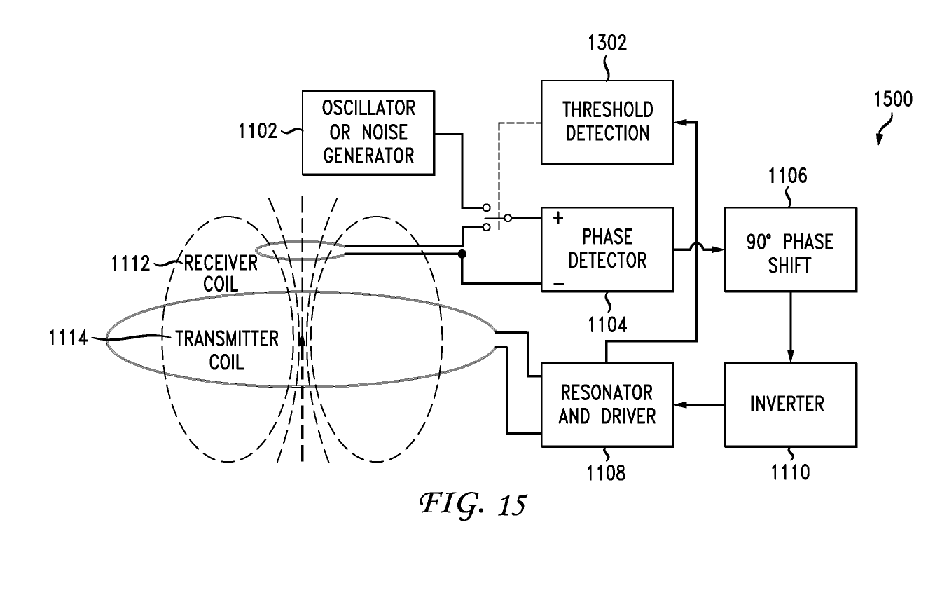

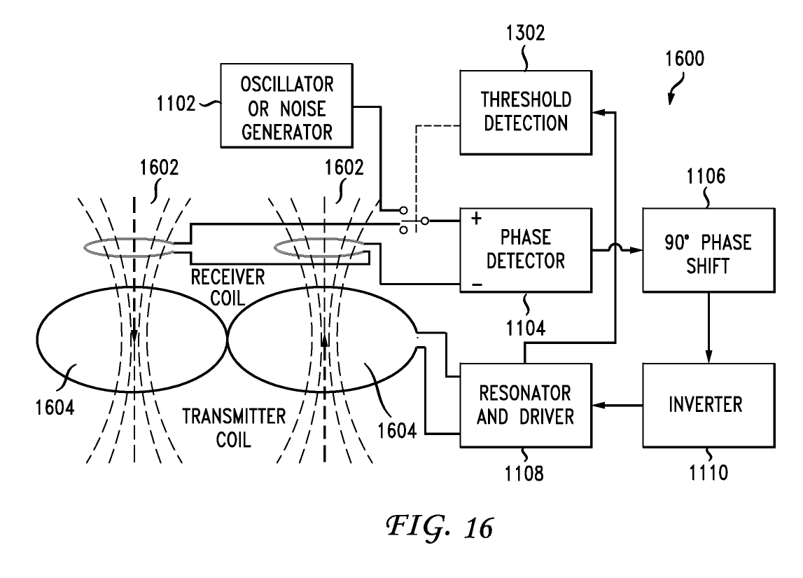

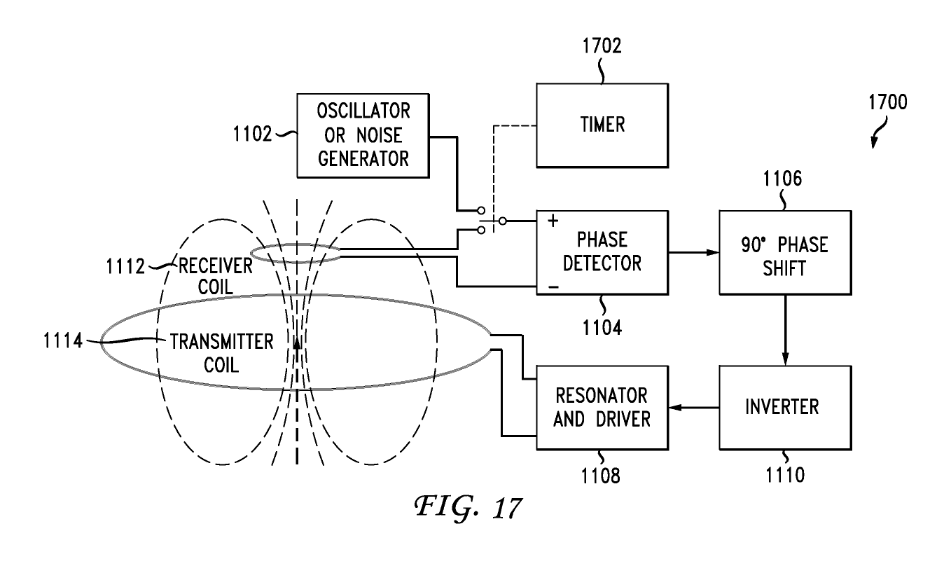

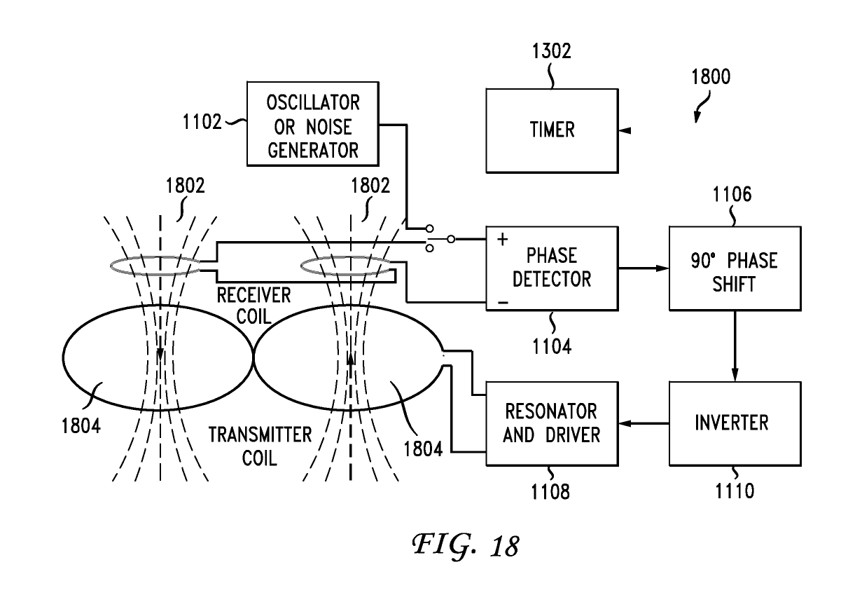

The other three sets of embodiments connect the initial drive signal and the derived drive signal to the two inputs of a MUX or switch and allow another function block to determine which drive signal should be used. The second embodiments 1300, 1400, which are displayed in FIGS. 13 and 14, determines the amplitude of the derived signal and switches to using that derived signal when its amplitude crosses a pre-defined threshold. For this embodiment, the initial drive signal is configured to be capable of inducing a sufficient current through the receiver coil 1112 to cross the threshold. The third embodiments 1500, 1600, which are displayed in FIGS. 15 and 16, determine the amplitude of the current flowing through the transmitter coil 1114 and switches to using the derived signal once the determined current amplitude crosses a pre-defined threshold. The initial drive signal is configured such that it is capable of inducing a sufficient current through the transmitter coil 1114 for the aforementioned threshold to be crossed. The fourth embodiments 1700, 1800, which are displayed in FIGS. 17-18, switches from the initial drive signal to the derived drive signal after a pre-defined period of time once power to the system is turned on.

These system embodiments create an oscillating electro-magnetic field within the relative vicinity of a transmitter coil 1114 by switching the polarity of the voltage across the transmitter coil 1114 at a precise frequency. The driver is a module that carries out the voltage polarity switches. The drive signal is an electrical or other signal that instructs the driver when to execute each voltage polarity switch. The system derives the drive signal for the oscillating electro-magnetic field generator 1102 from the field created by the generator itself by using one or two receiver coils 1112, 1202, 1402, 1602, 1802 to detect the generated field. An initial drive signal can remove the generator from an ‘off’ steady-state in which no current is flowing through the generator's transmitter coil 1114 or in which a minimal current is flowing through the transmitter coil 1114. Either of two alternate sources can provide the initial drive signal: (1) the voltage output of a crystal oscillator tuned within proximity of the generator's resonance frequency or (2) noise generated from a passive device such as a resistor. Either of these drive signals can initiate the operation of any embodiment. For ease of presentation, FIGS. 11-18 show this initial drive signal as a function block labeled oscillator or noise generator 1102 implying that the function block may represent either source of the initial drive signal, or some other suitable source.

The initial drive signal applies an alternating current to the generator's transmission coil 1114 when it is in the ‘off’ state. Regardless of whether the initial drive signal is created by noise or a crystal oscillator, because the transmitter coil 1114 is part of a resonator 1108, the majority of the current will alternate at or very close to its resonant frequency. This creates an alternating magnetic field that predominately oscillates at or close to the generator's resonant frequency. Once the generator's transmitter coil 1114 is generating a sufficiently large electro-magnetic field from the initial drive signal, the system begins using the drive signal derived from the generated field instead of the initial drive signal.

To ensure the switch from the initial to the derived drive signal does not immediately diminish the electro-magnetic field, whether that switch is gradual or immediate, the derived signal should be in-phase with the initial signal. When the derived signal becomes the dominant drive signal, the drive signal automatically approaches the resonant frequency of the generator.

One distinction exists from the four separate embodiments for migrating from the initial drive signal to the derived drive signal. The first group of embodiments, displayed in FIGS. 11, 13, 15 and 17, includes a single transmitter coil 1114 that can be any simple polygonal shape with any number of turns and a single receiver coil 1112 that can also be of any simple polygonal shape and any number of turns. The receiver coil 1112 and transmitter coil 1114 can be placed in an approximately coaxial configuration. The initial drive signal initiates current flow through the transmitter coil 1114 and the single receiver coil 1112 subsequently converts the electro-magnetic field created by the generator's transmission coil into a 90° phase-shifted voltage signal. A phase detector 1104 creates a square voltage signal from the voltage output from the receiver coil 1112.

The second group of embodiments, displayed in FIGS. 12, 14, 16 and 18, includes a single transmitter coil 1204, 1404, 1604, 1804 in the shape of a figure eight with any number of turns and two separate receiver coils 1202, 1402, 1602, 1802 that can be any simple polygonal shape and can include any number of turns. The two receiver coils 1202, 1402, 1602, 1802 can be placed in an approximately coaxial configuration with the two loops of the figure eight shaped transmitter coil 1204, 1404, 1604, 1804. The figure eight transmitter coil 1204, 1404, 1604, 1804 has its two loops placed next to each other on the same physical plane, but wound in opposite directions. When an alternating current is passed through the figure eight transmitter coil 1204, 1404, 1604, 1804, an electro-magnetic field is created that penetrates out of the top portion of one of the coil halves and dives back into the other coil half. Each of the receiver coils 1202, 1402, 1602, 1802 converts the electro-magnetic field at its center into a 90° phase-shifted voltage signal 1106. The phase detector 1104 creates a square voltage signal from the difference of the two coil's voltage outputs. The process of subtracting one of the signals from the other creates a single voltage signal, amplifying only the field generated by the figure eight transmitter coil 1204, 1404, 1604, 1804 by a factor of two, and eliminates any common mode noise in the two signals in the process.

In both of these groups of embodiments, once the phase detector 1104 creates a 90° phase-shifted square voltage signal 1106, that voltage signal is shifted another 90° and inverted by an inverter 1110 to bring it back in phase with the initial drive signal. The shifted and inverted drive signal is used to control the voltage polarity swaps across the transmitter coil 1114.

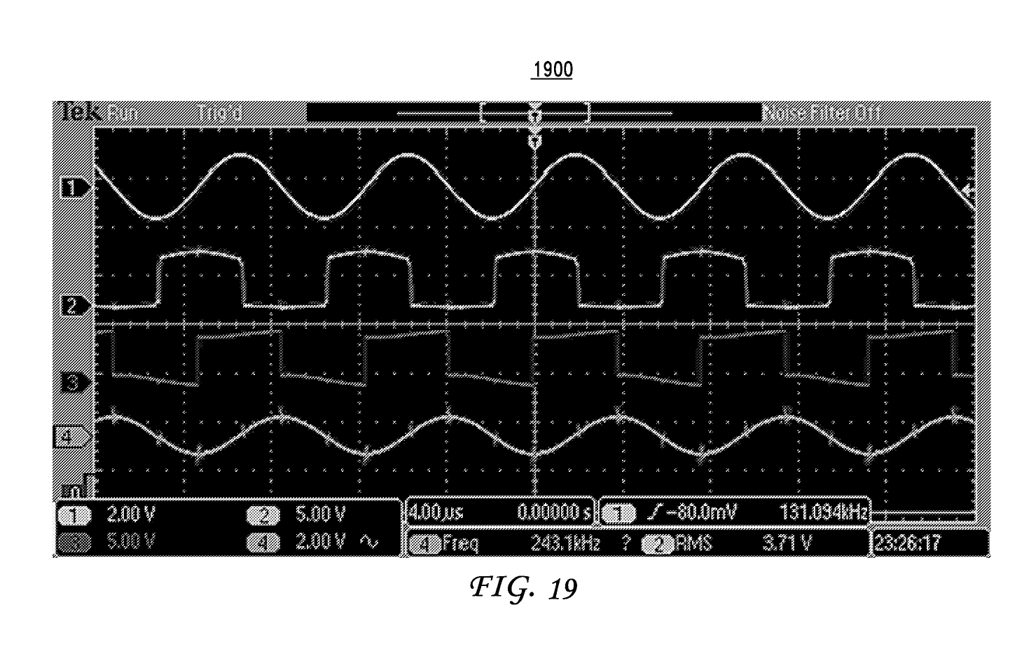

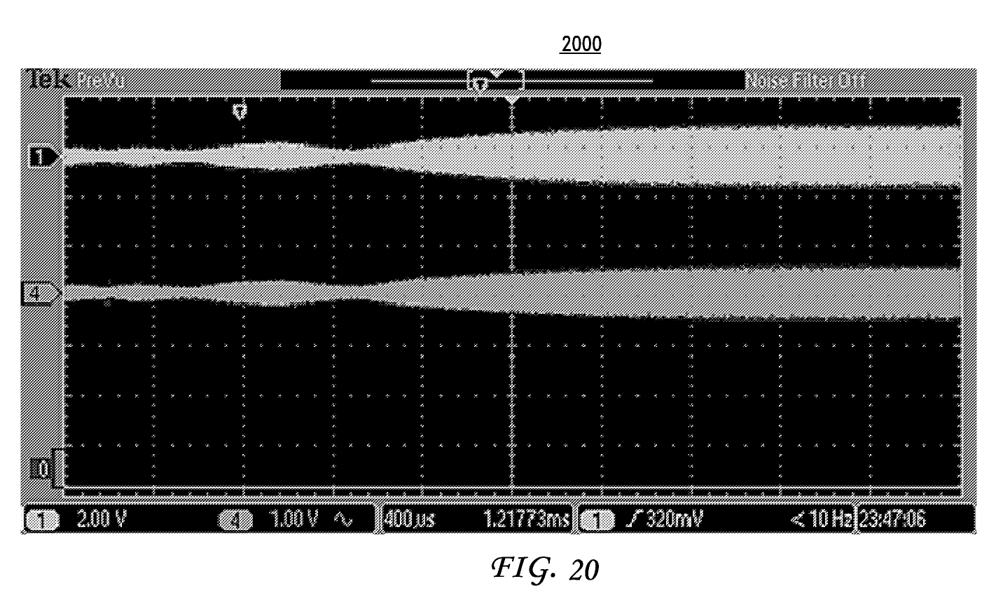

FIGS. 19 and 20 show oscilloscope captures of several signals recorded from an experimental prototype implementing what is shown in FIG. 11. This prototype of the system used a noise generator 1102 as the initial drive signal. The oscilloscope screen capture 1900 shown in FIG. 19 shows four signals within the functioning embodiment while the system is in an ‘on’ state, with the maximum amplitude of current flowing through the transmitter coil 1114. The four signals displayed in FIG. 19 are, from top to bottom, (1) the current through the transmitter coil 1114 with a conversion factor of 5 A/V, (2) the output of the phase detector 1104, (3) the output of the 90° phase shifter 1106, and (4) the voltage across the receiver coil 1112. The oscilloscope captures 2000 of FIG. 20 shows, from top to bottom, (1) the current through the transmitter coil 1114 with a conversion factor of 5 A/V and (2) the voltage across the receiver coil 1112 while the system is transitioning from being driven primarily by the noise signal to primarily by the derived drive signal.

A brief description of a basic general purpose system or computing device in FIG. 21, which can be employed to practice the concepts, is disclosed herein. With reference to FIG. 21, an exemplary system 2100 includes a general-purpose computing device 2100, including a processing unit (CPU or processor) 2120 and a system bus 2110 that couples various system components including the system memory 2130 such as read only memory (ROM) 2140 and random access memory (RAM) 2150 to the processor 2120. The system 2100 can include a cache 2122 of high speed memory connected directly with, in close proximity to, or integrated as part of the processor 2120. The system 2100 copies data from the memory 2130 and/or the storage device 2160 to the cache 2122 for quick access by the processor 2120. In this way, the cache provides a performance boost that avoids processor 2120 delays while waiting for data. These and other modules can control or be configured to control the processor 2120 to perform various actions. Other system memory 2130 may be available for use as well. The memory 2130 can include multiple different types of memory with different performance characteristics. It can be appreciated that the disclosure may operate on a computing device 2100 with more than one processor 2120 or on a group or cluster of computing devices networked together to provide greater processing capability. The processor 2120 can include any general purpose processor and a hardware module or software module, such as module 1 2162, module 2 2164, and module 3 2166 stored in storage device 2160, configured to control the processor 2120 as well as a special-purpose processor where software instructions are incorporated into the actual processor design. The processor 2120 may essentially be a completely self-contained computing system, containing multiple cores or processors, a bus, memory controller, cache, etc. A multi-core processor may be symmetric or asymmetric.

The system bus 2110 may be any of several types of bus structures including a memory bus or memory controller, a peripheral bus, and a local bus using any of a variety of bus architectures. A basic input/output (BIOS) stored in ROM 2140 or the like, may provide the basic routine that helps to transfer information between elements within the computing device 2100, such as during start-up. The computing device 2100 further includes storage devices 2160 such as a hard disk drive, a magnetic disk drive, an optical disk drive, tape drive or the like. The storage device 2160 can include software modules 2162, 2164, 2166 for controlling the processor 2120. Other hardware or software modules are contemplated. The storage device 2160 is connected to the system bus 2110 by a drive interface. The drives and the associated computer readable storage media provide nonvolatile storage of computer readable instructions, data structures, program modules and other data for the computing device 2100. In one aspect, a hardware module that performs a particular function includes the software component stored in a non-transitory computer-readable medium in connection with the necessary hardware components, such as the processor 2120, bus 2110, display 2170, and so forth, to carry out the function. The basic components are known to those of skill in the art and appropriate variations are contemplated depending on the type of device, such as whether the device 2100 is a small, handheld computing device, a desktop computer, or a computer server.

Although the exemplary embodiment described herein employs the hard disk 2160, it should be appreciated by those skilled in the art that other types of computer readable media which can store data that are accessible by a computer, such as magnetic cassettes, flash memory cards, digital versatile disks, cartridges, random access memories (RAMs) 2150, read only memory (ROM) 2140, a cable or wireless signal containing a bit stream and the like, may also be used in the exemplary operating environment. Non-transitory computer-readable storage media expressly exclude media such as energy, carrier signals, electromagnetic waves, and signals per se.

To enable user interaction with the computing device 2100, an input device 2190 represents any number of input mechanisms, such as a microphone for speech, a touch-sensitive screen for gesture or graphical input, keyboard, mouse, motion input, speech and so forth. An output device 2170 can also be one or more of a number of output mechanisms known to those of skill in the art. In some instances, multimodal systems enable a user to provide multiple types of input to communicate with the computing device 2100. The communications interface 2180 generally governs and manages the user input and system output. There is no restriction on operating on any particular hardware arrangement and therefore the basic features here may easily be substituted for improved hardware or firmware arrangements as they are developed.

For clarity of explanation, the illustrative system embodiment is presented as including individual functional blocks including functional blocks labeled as a “processor” or processor 2120. The functions these blocks represent may be provided through the use of either shared or dedicated hardware, including, but not limited to, hardware capable of executing software and hardware, such as a processor 2120, that is purpose-built to operate as an equivalent to software executing on a general purpose processor. For example the functions of one or more processors presented in FIG. 21 may be provided by a single shared processor or multiple processors. (Use of the term “processor” should not be construed to refer exclusively to hardware capable of executing software.) Illustrative embodiments may include microprocessor and/or digital signal processor (DSP) hardware, read-only memory (ROM) 2140 for storing software performing the operations discussed below, and random access memory (RAM) 2150 for storing results. Very large scale integration (VLSI) hardware embodiments, as well as custom VLSI circuitry in combination with a general purpose DSP circuit, may also be provided.

The logical operations of the various embodiments are implemented as: (1) a sequence of computer implemented steps, operations, or procedures running on a programmable circuit within a general use computer, (2) a sequence of computer implemented steps, operations, or procedures running on a specific-use programmable circuit; and/or (3) interconnected machine modules or program engines within the programmable circuits. The system 2100 shown in FIG. 21 can practice all or part of the recited methods, can be a part of the recited systems, and/or can operate according to instructions in the recited non-transitory computer-readable storage media. Such logical operations can be implemented as modules configured to control the processor 2120 to perform particular functions according to the programming of the module. For example, FIG. 21 illustrates three modules Mod1 2162, Mod2 2164 and Mod3 2166 which are modules configured to control the processor 2120. These modules may be stored on the storage device 2160 and loaded into RAM 2150 or memory 2130 at runtime or may be stored as would be known in the art in other computer-readable memory locations.

Embodiments within the scope of the present disclosure may also include tangible and/or non-transitory computer-readable storage media for carrying or having computer-executable instructions or data structures stored thereon. Such non-transitory computer-readable storage media can be any available media that can be accessed by a general purpose or special purpose computer, including the functional design of any special purpose processor as discussed above. By way of example, and not limitation, such non-transitory computer-readable media can include RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Those of skill in the art will appreciate that other embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The various embodiments described above are provided by way of illustration only and should not be construed to limit the scope of the disclosure. For example, the principles herein can apply to providing power to any freely mobile objects, such as animals, toys, mobile electronic devices, remote controlled devices, and so forth. Those skilled in the art will readily recognize various modifications and changes that may be made to the principles described herein without following the example embodiments and applications illustrated and described herein, and without departing from the spirit and scope of the disclosure.

We claim:

1. A method comprising:
generating, via a generator coil, an electro-magnetic field for transmitting power to a mobile wireless power receiver;
receiving, from the mobile wireless power receiver, magnetic field information detected at the mobile wireless power receiver;
upon detecting a change in the electro-magnetic field based on the magnetic field information, deriving a timing signal from the electro-magnetic field; and
controlling a frequency at which a polarity of voltage across the generator coil oscillates based on the timing signal, so that the electro-magnetic field generator oscillates at its resonant frequency.

2. The method of claim 1, further comprising:
identifying the generator coil from an array of generator coils based on an indication that at least one mobile wireless power receiver is proximate to the generator coil.

3. The method of claim 1, further comprising:
receiving, from multiple mobile wireless power receivers, magnetic field information detected at each of the multiple mobile wireless power receivers.

4. The method of claim 1, further comprising:
receiving the magnetic field information via a base station; and
controlling the frequency via a transmitter controller.

5. A wireless power transmitter comprising:
a resonator comprising a generator and a transmitter coil;
an initial drive signal generator which applies an initial drive signal comprising an alternating current signal, the initial drive signal removing the generator from an off state thereby causing the transmitter coil to create an alternating magnetic field that oscillates within a threshold of a resonant frequency of the generator;
a phase detector that receives a signal from a receiver coil receiving power via the alternating magnetic field from the transmitter coil; and
a transition module that switches from the initial drive signal to a drive signal generated based on output from the phase detector.

6. The wireless power transmitter of claim 5, further comprising:
a phase shifter module that phase shifts the drive signal by 90 degrees.

7. The wireless power transmitter of claim 5, further comprising:
a phase inverter module that inverts the drive signal to bring the drive signal back in phase with the initial drive signal.

8. The wireless power transmitter of claim 5, wherein the initial drive signal generator comprises at least one of an oscillator or a noise generator.

9. The wireless power transmitter of claim 5, wherein the transmitter coil comprises a single transmitter coil of a simple polygonal or circular shape.

10. The wireless power transmitter of claim 5, wherein the transmitter coil comprises a single transmitter coil in a figure eight shape.

11. The wireless power transmitter of claim 5, wherein the phase detector creates the drive signal as a square voltage signal from a voltage output received from the receiver coil.

12. A wireless power receiver comprising:
a ferrite plate;
a first antenna comprising a first set of turns of wire around the ferrite plate in an X axis;
a second antenna comprising a second set of turns of wire around the ferrite plate in a Y axis;
a third antenna comprising a third set of turns of wire around the ferrite plate in a Z axis;
wherein the first antenna, the second antenna, and the third antenna produce outputs when in the presence of an alternating magnetic field generated by a transmitter coil; and
a connector that connects the outputs in parallel to produce a combined output signal.

13. The wireless power receiver of claim 12, further comprising:
a low Curie temperature ferrite flux concentrator configured to reduce permeability of the low Curie temperature ferrite flux concentrator as a temperature of the low Curie temperature ferrite flux concentrator increases above a threshold, and to increase permeability of the low Curie temperature ferrite flux concentrator as the temperature of the low Curie temperature ferrite flux concentrator decreases below the threshold.

14. The wireless power receiver of claim 13, wherein the low Curie temperature ferrite flux concentrator comprises at least one of MnZn or NiZn.

15. The wireless power receiver of claim 13, wherein the threshold for the low Curie temperature ferrite flux concentrator is between 37 degrees Celsius and 80 degrees Celsius.

16. The wireless power receiver of claim 12, wherein the connector comprises a low loss capacitor having a value such that each antenna resonates at a driving frequency of the transmitter coil.

17. The wireless power receiver of claim 12, further comprising:
a rectification module that rectifies the outputs prior to producing the combined output signal.

18. The wireless power receiver of claim 12, further comprising:
a power storage module for storing power received via the combined output signal.

19. The wireless power receiver of claim 18, wherein the power storage module comprises at least one of a battery, capacitor, or supercapacitor.

20. The wireless power receiver of claim 12, wherein each of the first set of turns of wire, the second set of turns of wire, and the third set of turns of wire comprises between 40 and 60 turns.
